(19) United States
(12) Patent Application Publication
(10) Pub. No.: US 2012/0290594 A1
(43) Pub. Date: Nov. 15, 2012

(54) EVENT/PERFORMANCE DATA AGGREGATION, MONITORING, AND FEEDBACK PLATFORM

(75) Inventor: Joseph M. Callahan, Bryn Mawr, PA (US)

(73) Assignee: Ciright Systems, Inc., West Conshohocken, PA (US)

(21) Appl. No.: 13/469,785

(22) Filed: May 11, 2012

Related U.S. Application Data
(60) Provisional application No. 61/485,540, filed on May 12, 2011.

(51) Int. Cl. G06F 17/30

(52) U.S. Cl. 707/755; 707/E17.058

(57) ABSTRACT

A computer-implemented system and methods are provided to allow for the remote/wireless event/performance data aggregation, monitoring, and feedback to generate real time performance metric data for participating individuals of an event/performance that can be used to provide various feedback to the participating individuals regarding the participating individuals' efforts during an event/performance. In an illustrative implementation, exemplary server computer environment is operable to electronically/wireless communicate with one or more sensor/data aggregator mechanisms capable of aggregating one or more desired data inputs and to a display device operable to display exemplary generated event performance metric data. In an illustrative operation, the exemplary server computing environment polls one or more cooperating sensor/data input mechanisms over a cooperating communications network/protocol for data over a selected time interval to generate real-time performance metric data that can be communicated by the exemplary computing environment to a cooperating data display device over a cooperating communications network.

### CROSS REFERENCE TO RELATED APPLICATIONS

This application claims the benefit of U.S. Provisional Application No. 61/485,540, filed May 12, 2011.

### BACKGROUND OF THE INVENTION

Advances in data aggregation, monitoring, and control technologies have afforded a number of applications and solutions that allow for precise measurement and control over various systems and platforms. Often system and platform operators can perform the data aggregation and control operations deployed on purposed computing network and such operations can be performed remotely over a preferred communications network—e.g., the Internet. The key differentiator among the various data, aggregation, and control technologies that are in current practice are the types of data that can be aggregated which is typically delimited by available sensor/input technologies as well as how such aggregated data is displayed to a participating user.

Often, current data monitoring display paradigms lack sophisticate interactivity to allow participating users to quickly digest numerous inter-related aggregated data inputs, decipher the impact of such inputs on a particular observed event, and, more importantly, provide feedback to the observed system to adjust, configure, and/or optimize the observed system responsive to a particular observed event. Additionally, although there a number of data aggregation, monitoring, control technologies that address (and/or automate) the monitoring, management, and control over various control systems current practices do not provide a comprehensive event/performance wireless data, aggregation, monitoring, and feedback platform for use in observing the performance of individuals who are performing a given desired observed event—e.g., training for a particular sport, undertaking a sporting event, taking a written/physical/psychological test, performing an endurance test, etc.

Additionally, current practices do not provide the ability for such data aggregation and monitoring systems to provide one or more recommendations to a participating user using base-line optimal performance data as a comparison to the aggregated data for an observed event. Such recommendations can be provided in real time to allow participating users to adjust their efforts during a performance/event to improve one or more performance metrics.

From the foregoing, it is appreciated that there exists a need for systems and methods that are aimed to ameliorate the shortcomings of existing practices.

### SUMMARY OF THE INVENTION

Applicant has noted that current data monitoring display paradigms lack sophisticate interactivity to allow participating users to quickly digest numerous inter-related aggregated data inputs, decipher the impact of such inputs on a particular observed event, and, more importantly, provide feedback to the observed system to adjust, configure, and/or optimize the observed system responsive to a particular observed event. Additionally, although there a number of data aggregation, monitoring, control technologies that address (and/or automate) the monitoring, management, and control over various control systems, current practices do not provide a comprehensive event/performance wireless data, aggregation, monitoring, and feedback platform for use in observing the performance of individuals who are performing a given desired observed event—e.g., training for a particular sport, undertaking a sporting event, taking a written/physical/psychological test, performing an endurance test, etc.

Additionally, current practices do not provide the ability for such data aggregation and monitoring systems to provide one or more recommendations to a participating user using base-line optimal performance data as a comparison to the aggregated data for an observed event. Such recommendations can be provided in real time to allow participating users to adjust their efforts during a performance/event to improve one or more performance metrics.

Applicant discloses herein a computer-implemented interactive system and methods that allow for the remote/wireless event/performance data aggregation, monitoring, and feedback to generate in real time desired performance metric data for participating individuals (i.e., participating in an event/performance) that can be used to provide various feedback to the participating individuals regarding the participating individuals' efforts during an event/performance. In an illustrative implementation, the computer-implemented interactive system comprises an exemplary server computer environment operable to electronically/wireless communicate with one or more sensor/data aggregator mechanisms capable of aggregating one or more desired data inputs and to a display device operable to display exemplary generated event performance metric data. In an example embodiment, the disclosed system and methods may be used to aggregate data for, and provide feedback to individuals participating in a sporting event or workout such as, for example a rowing race or practice.

In an illustrative operation, the exemplary server computing environment polls one or more cooperating sensor/data input mechanisms over a cooperating communications network/protocol for data over a selected time interval. The aggregated data is processed by an illustrative computing application to generate real-time performance metric data that can be communicated by the exemplary computing environment to a cooperating data display device over a cooperating communications network. In the illustrative operation, the exemplary computing application operatively processes the aggregated sensor data according to one or more instructions when generating the real-time performance metric data and compares the aggregated sensor data to base-line optimal performance data (i.e., base-line optimal performance data for an observed event) to generate one or more recommendations regarding the effort being put forth by one or more participating individuals participating in an observed event/performance.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features of the herein described systems and methods are further described below.

### BRIEF DESCRIPTION OF THE DRAWINGS

The present invention will hereinafter be described in conjunction with the appended drawing figures wherein like numerals denote like elements.

The interactive systems and methods for event/performance data aggregation, monitoring, and feedback are described with reference to the accompanying drawings in which:

FIG. 1 is a block diagram of an exemplary computing environment in accordance with an implementation of the herein described systems and methods;

FIG. 2 is a block diagram showing the cooperation of exemplary components of an illustrative implementation in accordance with the herein described systems and methods;

FIG. 3 is a block diagram showing the cooperation of exemplary components of another illustrative implementation in accordance with the herein described systems and methods;

FIG. 4 is a flow diagram showing an illustrative method for the aggregation, monitoring, and feedback of event/performance data in accordance with the herein described systems and methods;

FIG. 5 is a flow diagram showing an illustrative method for the generation of performance metric data for use in providing one or more recommendations regarding effort levels of participating individuals in a particular event/performance; and

FIG. 6 is a screen shot of exemplary displayable performance metric data and recommendation data in accordance with the herein described systems and methods.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms are used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

Illustrative Computing Environment

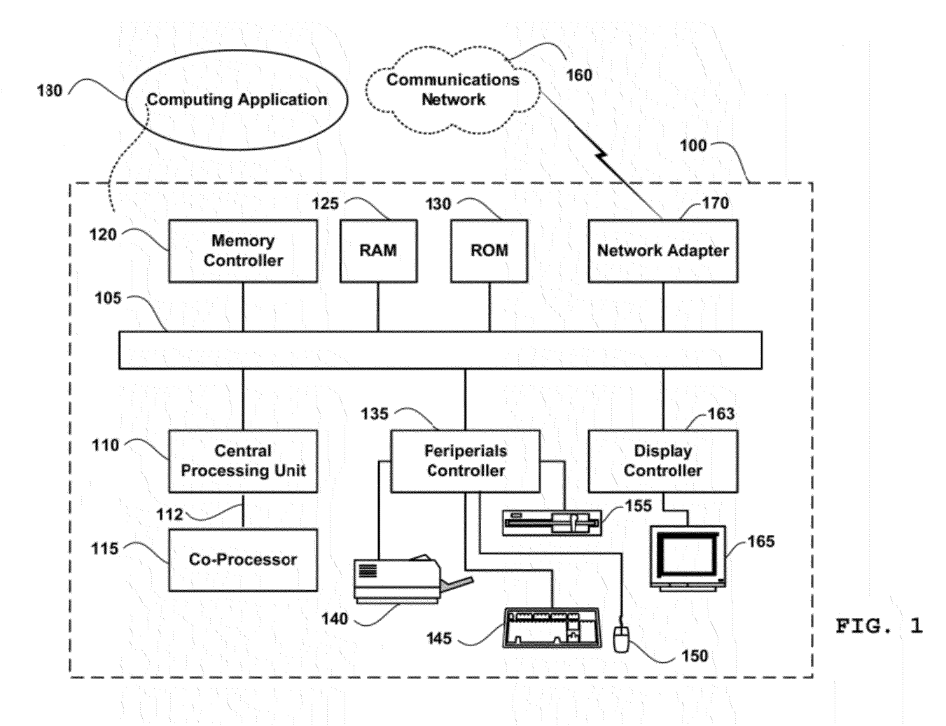

FIG. 1 depicts an exemplary computing system 100 in accordance with herein described system and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers, CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to an external communication network 160.

Illustrative Computer Network Environment

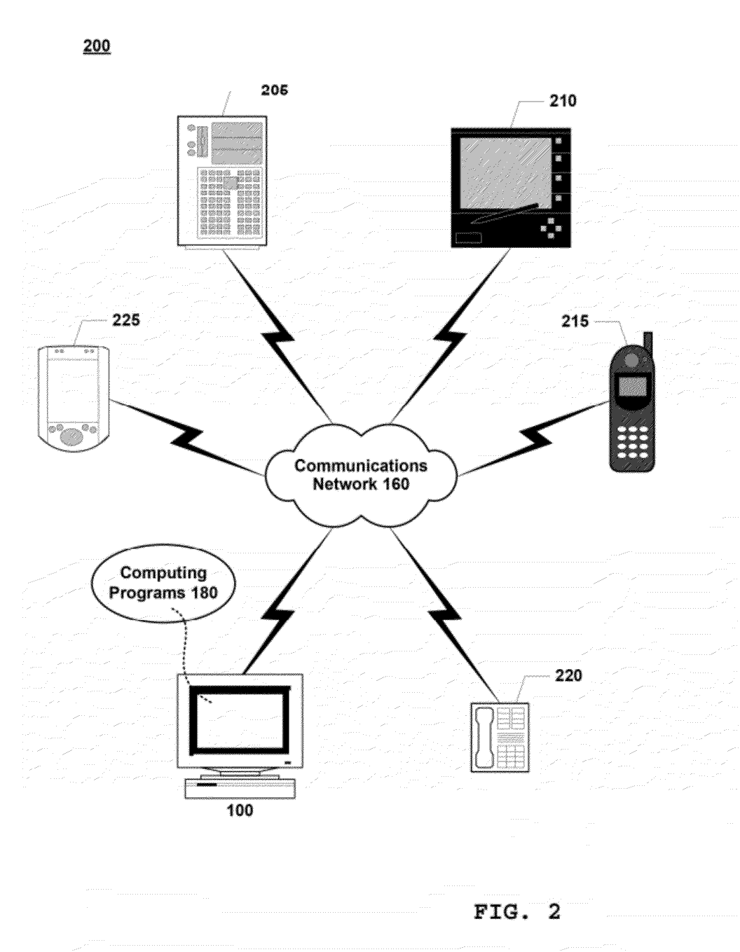

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, and personal digital assistance 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system 180 operable to support one or more computing applications, such as a web browser (not shown), or other graphical user interface (not shown), or a mobile desktop environment (not shown) to gain access to server computing environment 205.

Server 205 may be communicatively coupled with sensors and receive data regarding the performance of individuals during an event. For example, in an illustrative embodiment, server 205 may be communicatively coupled via a network with sensors that collect data regarding the performance of competitors in a sporting event.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

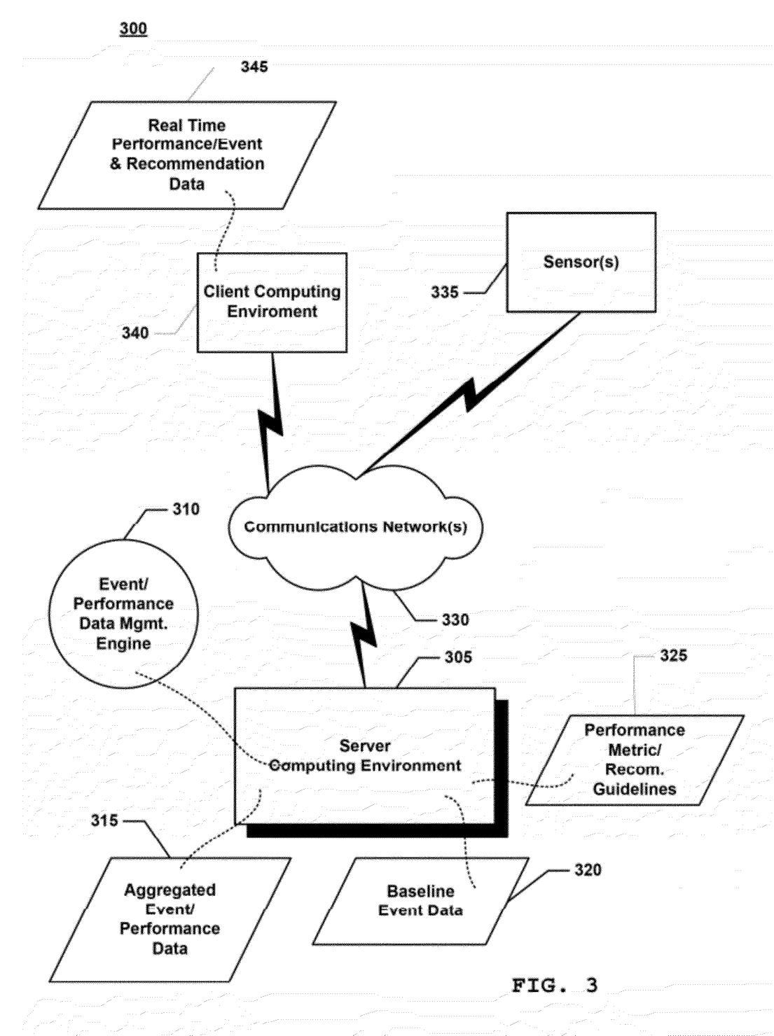

FIG. 3 shows an illustrative implementation of exemplary event/performance data aggregation, monitoring, and feedback environment 300. As is shown, exemplary event/performance data aggregation, monitoring, and feedback environment 300 comprises server computing environment 305, communications network(s) 330, client computing environment 340 (e.g., cooperating display device), and sensor(s) 335. Additionally, as is shown, server computing environment 305 is operable to execute event/performance data management engine 310 and store/retrieve data from various data stores including but not limited to aggregated event/performance data store 315, baseline event data store 320, and performance metric/recommendation guidelines data store 325. Additionally, client computing environment 340 is operable to display and provide interactive controls to manipulate, change, and view real time performance/event and recommendation data 345.

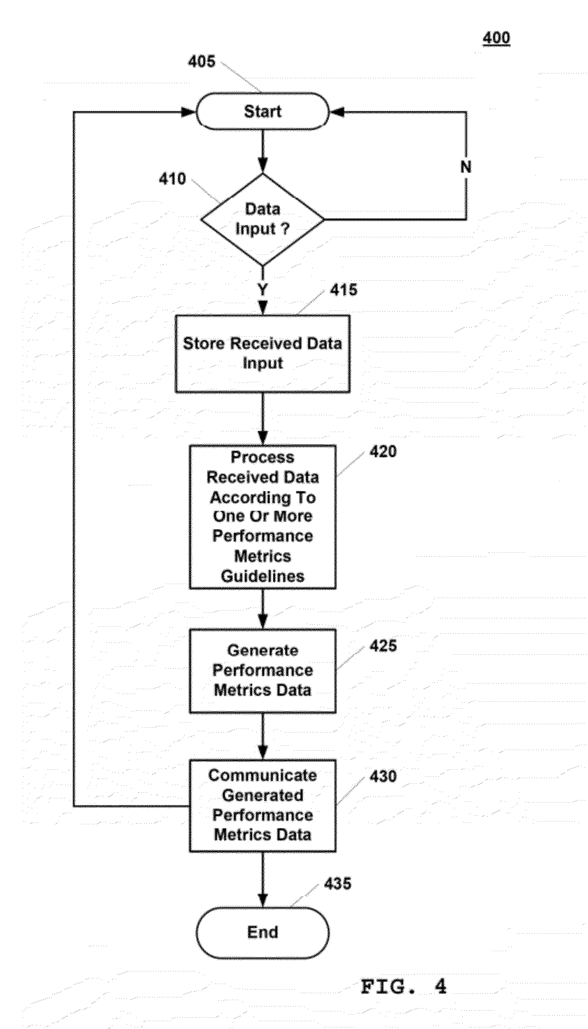

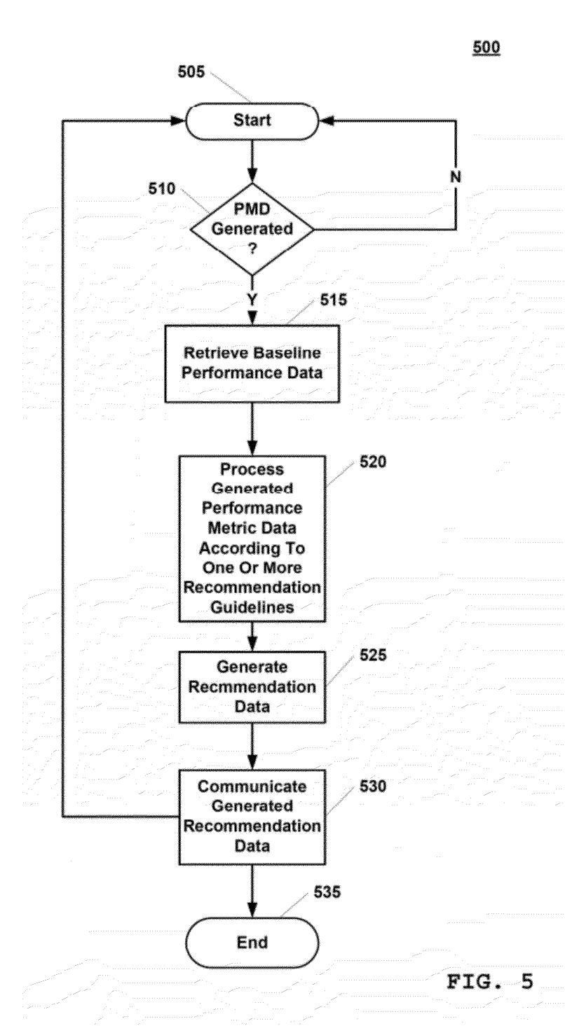

In an illustrative operation, server computing environment can receive various data inputs from sensor(s) 335 for storage in aggregated event/performance data store and for processing by event/performance data management engine 310 to generate real time performance metric data and/or recommendation data 345 for communication to client computing environment 340 over communication network(s) 330. Sensors 335 may collect any performance data that is suitable. In an example embodiment, sensors 335 may collect data relating to the performance of one or more athletes over a period of time. In the illustrative operation, event/performance data management engine 310 can process received data inputs according to one or more performance metric guidelines that can be retrieved from performance metric/recommendation guidelines data store 325 to generate performance metric data (e.g., according to exemplary method 400 of FIG. 4). For example, in an example embodiment directed to athletic performance, metric guideline data may specify desired or prescribed performance targets such as, for example, speed, repetition rate, heart rate, etc. Additionally, in the illustrative operation, event/performance data management engine 310 can process generated performance metric data to generate recommendation data (e.g., according to exemplary method 500 of FIG. 5) using one or more recommendation guidelines that can be retrieved from performance metric/recommendation guidelines data store 325. In an example embodiment directed to athletic performance, for example, recommendation guidelines may specify that an athlete increase or decrease his/her cadence in order to obtain a desired outcome.

FIG. 4 shows exemplary method 500 describing illustrative processing performed in connection with processing data for generating performance recommendation data as part of the operation of an exemplary event/performance data aggregation, monitoring, and feedback platform. As is shown, processing begins at block 405 and proceeds to block 410 where a check is performed to determine if exemplary data aggregation, monitoring, and feedback platform (not shown) has received one or more data inputs from one or more cooperating environment sensors (not shown). If the check at block 410 indicates that data inputs have not been received, processing reverts to block 400 and proceeds from there.

However, if the check at block 410 indicates that data inputs have been received, processing proceeds to block 415 where the received data is stored for subsequent processing. At block 420, according to one or more performance data guidelines the received data inputs are parsed and formatted according to one or more rules provided by performance metrics guidelines for presentation according to a selected one or more display formats (e.g., text and/or graphical representation). Processing then proceeds to block 425 where performance metrics data is generated. At block 430, the generated recommendation data is communicated to one or more cooperating computing devices. Processing can then revert to block 405 or terminate at block 435.

FIG. 5 shows exemplary method 500 describing illustrative processing 7 performed in connection with processing data for generating recommendation data as part of the operation of an exemplary event/performance data aggregation, monitoring, and feedback platform. As is shown, processing begins at block 505 and proceeds to block 510 where a check is performed to determine if performance metric data has been generated by exemplary event/performance data aggregation, monitoring, and feedback platform (not shown). If the check at block 510 indicates that performance metric data has not been generated, processing reverts to block 500 and proceeds from there.

However, if the check at block 510 indicates that performance metric data has been generated, processing proceeds to block 515 where baseline performance data is retrieved for processing at block 520 according to one or more recommendation data guidelines. In an example embodiment directed to athletic performance, for example, baseline performance data may specify anticipated performance guidelines, such as, for example, speed, cadence, heart rate, that an athlete should be matching. Processing then proceeds to block 525 where recommendation data is generated by performing a comparison of the retrieved baseline data and the resultant data set resulting from one or more calculations provided by recommendation data guidelines that is performed on the generated performance metric data. In an example embodiment directed to athletic performance, for example, the performance data representing the actual performance of an athlete is compared to the baseline performance data to identify deficiencies in performance. Using the noted deficiencies, recommendation guidelines are queried to identify corrective or recommended actions that should be taken in order to arrive at the desired objective. Processing then proceeds to block 530 where the generated recommendation data is communicated to one or more cooperating computing devices. Processing can then revert to block 505 or terminate at block 535.

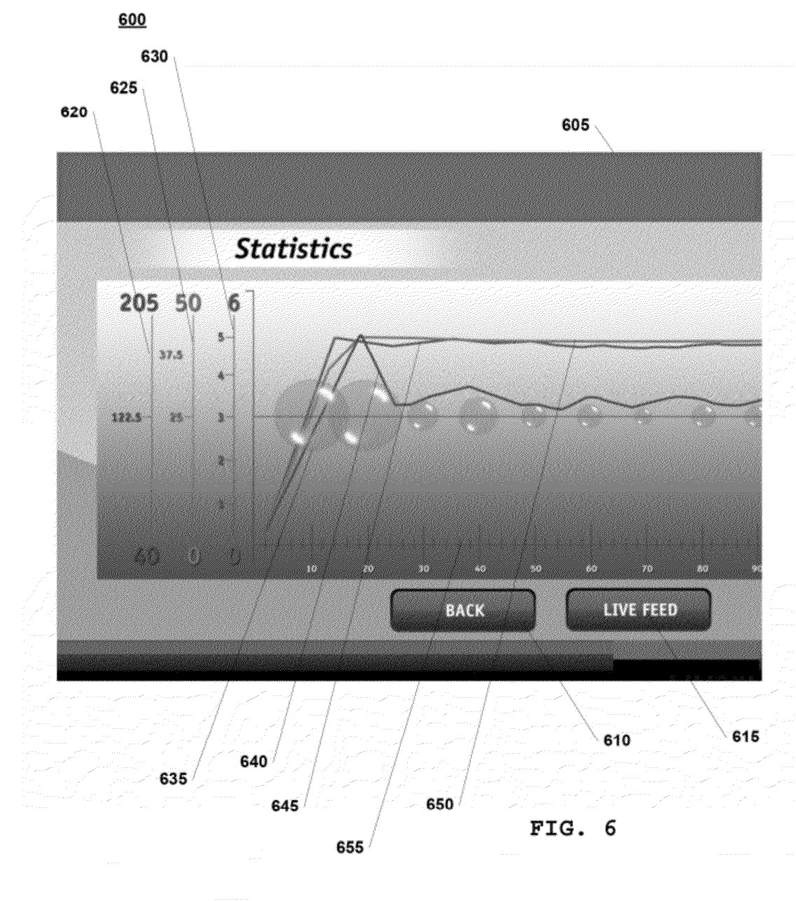

FIG. 6 shows exemplary screen shot 600 the content of which can be displayed on an exemplary cooperating display device (not shown). As is shown, exemplary screen shot 600 comprises display pane 605 that is capable of displaying various text and graphical data (620, 625, 630, 640, 645, and 650) as well as providing various navigation features (e.g., navigation buttons 610 and 615). In an illustrative implementation, exemplary screen shot 600 can comprise data representative of the effort being put forth by a crew team (rowing in a boat on the water) as part a team's practice or during a race in which the crew team is participating. In the illustrative implementation, exemplary display pane 605 can display, in real time, various performance data, for example heart rate 620, number of oar strokes per minute 625, and boat speed 630. Additionally, as is shown, exemplary display pane 605 is operable to display this various performance data as a function of time intervals 655 in graphical format 640, 645, and 650, respectively.

Furthermore, additional generated performance data 635 can be calculated according to a comparison of baseline (e.g., ideal) and performance data (not shown), and graphically represented in various formats (e.g., bubbles 635). In an illustrative implementation, graphical bubbles 635 can represent a correlation between the speed of the rowers' slide seat compared to the speed of the rowers' oar throw/turn in relation to the speed of the boat to provide a representation of the boat's power factor/power optimization.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments, including cell phones and video phones), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

1. A system for aggregating, monitoring, and calculating feedback for event/performance data, comprising:
a computing processor; and
computing memory communicatively coupled with the computing processor, the computing memory having stored therein instructions that, if executed by the computing processor, cause the computing processor to perform operations comprising:
receiving data from one or more cooperating sensors operative to collect various performance data related to a specific event/performance;
parsing the received sensor data to separate the received sensor data according to one or more sensor types; and
calculating performance metric data using baseline performance data comprising data representative of an ideal performance and using one or more performance guidelines and using the received sensor data according to one or more equations that comprises one or more variables representative of one or more characteristics of the event/performance and to generate performance optimization recommendation data; and
communicating the generated performance optimization recommendation data to one or more cooperating data display and navigation electronic devices.

2. The system as recited in claim 1, wherein the one or more cooperating sensors comprise sensors specific to the event/performance.

3. The system as recited in claim 2, wherein the calculating performance metric data is performed by a computing application executing on the computing processor.

4. The system as recited in claim 2, further comprising a communications network operative to communicate data between the computing processor and the one or more cooperating data display and navigation electronic devices.

5. The system as recited in claim 4, wherein the one or more cooperating data display and navigation electronic devices comprises a tablet computing device, a mobile phone, a personal computer, and smart phone.

6. The system as recited in claim 1, wherein the one or more equations comprise equations descriptive of the bio-mechanical activity of one or more participants that are participating in the event/performance

7. The system as recited in claim 1, further comprising formatting the received data and the generated performance metric data according to one or more selected display formats to generate optimized performance metric data;

8. The system as recited in claim 1, further comprising a communications module operatively coupled with the computer process to allow for the communication of data between the one or more cooperating sensors and the computer processor.

9. The system as recited in claim 1, further comprising one or more displays operative to display the generated performance optimization recommendation data.

10. The system as recited in claim 9, wherein the one or more displays are geographically located proximate to a participant that is participating in the event/performance.

11. A method for aggregating, monitoring, and calculating feedback for event/performance data, comprising:
receiving data from one or more cooperating sensors operative to collect various performance data related to a specific event/performance;
parsing the received sensor data to separate the received sensor data according to one or more sensor types; and
calculating performance metric data using baseline performance data comprising data representative of an ideal performance and using one or more performance guidelines and using the received sensor data according to one or more equations that comprises one or more variables representative of one or more characteristics of the event/performance and to generate performance optimization recommendation data; and
communicating the generated performance optimization recommendation data to one or more cooperating data display and navigation electronic devices.

12. The method as recited in claim 11, further comprising activating sensors that are specific to the event/performance.

13. The method as recited in claim 12, wherein the calculating performance metric data comprises executing a computing application having one or more instructions to generate the performance optimization recommendation data.

14. The method as recited in claim 12, further comprising communicating data to the data display and navigation electronic devices over a communications network.

15. The method as recited in claim 14, further comprising communicating data to the data display and navigation electronic devices over a communications network, the devices comprising a tablet computing device, a mobile phone, a personal computer, and smart phone.

16. The method as recited in claim 11, wherein calculating the performance metric data comprises using one or more equations descriptive of the bio-mechanical activity of one or more participants that are participating in the event/performance

17. The method as recited in claim 11, further comprising formatting the received data and the generated performance metric data according to one or more selected display formats to generate optimized performance metric data;

18. The method as recited in claim 11, further comprising providing a communicating data between the one or more cooperating sensors and a cooperating computing environment for subsequent processing.

19. The method as recited in claim 11, further comprising communicating the generated performance optimization recommendation data to one or more cooperating displays.

20. The system as recited in claim 19, further comprising communicating the generated performance optimization recommendation data to one or more cooperating displays that are proximate to a participant that is participating in the event/performance.
